(19) United States
(12) Patent Application Publication
(10) Pub. No.: US 2019/0100135 A1
(43) Pub. Date: Apr. 4, 2019

(54) ACCELERATION EVENT-BASED PASSENGER NOTIFICATION SYSTEM

(71) Applicant: Waymo LLC, Mountain View, CA (US)

(72) Inventors: Juliet Rothenberg, San Francisco, CA (US); Nirmal Patel, Sunnyvale, CA (US); Renaud-Roland Hubert, Gilroy, CA (US); Ioan-Alexandru Sucan, Mountain View, CA (US); Julien Charles Mercay, Redwood City, CA (US); Keith Hutchings, San Jose, CA (US); Peter Crandall, San Jose, CA (US); Ryan Powell, San Francisco, CA (US)

(21) Appl. No.: 15/722,176

(22) Filed: Oct. 2, 2017

(51) Int. Cl. B60Q 1/44; B60K 31/18; B60Q 1/54

(52) U.S. Cl. CPC B60Q 1/445; B60Q 1/54; B60K 31/18

(57) ABSTRACT

Aspects of the present disclosure relate to generating notifications of acceleration events for a vehicle operating in an autonomous driving mode. As an example, instructions generated by a planning system of the vehicle are monitored. Determining whether the instructions identify changes in lateral and longitudinal acceleration for the autonomous driving mode. That an acceleration threshold will be met when the vehicle proceeds according to the changes is determined. A notification is generated based on the determination that an acceleration threshold will be met, the notification identifying that an acceleration event has occurred. The notification is displayed to a passenger of the vehicle on a display of the vehicle.

### BACKGROUND

Autonomous vehicles, such as vehicles that do not require a human driver, can be used to aid in the transport of passengers or items from one location to another. Such vehicles typically function with little to no passenger input, for instance, only to provide a destination for the vehicle or some other initiating input. Because of this, a passenger would typically not have any understanding of why a vehicle took a particular action other than those which are clearly aimed at maneuvering the vehicle towards the destination. This means that sudden movements by the vehicle, even if for safety or other reasons, can cause anxiety or stress for the passenger.

### BRIEF SUMMARY

One aspect of the disclosure provides a method of generating notifications of acceleration events for a vehicle operating in an autonomous driving mode. The method includes monitoring, by one or more processors, instructions generated by a planning system of the vehicle; determining, by the one or more processors, that the instructions would result in changes in lateral and longitudinal acceleration for the autonomous driving mode; determining, by the one or more processors, whether an acceleration threshold will be met when the vehicle proceeds according to the changes; generating, by the one or more processors, a notification based on the determination that an acceleration threshold will be met, the notification identifying that an acceleration event has occurred; and displaying on a display of the vehicle the notification to a passenger of the vehicle.

In one example, the method also includes identifying an object in the vehicle's environment that caused a change in the lateral and longitudinal acceleration corresponding to the acceleration event, and wherein generating the notification is further based on the object such that the notification identifies the type of the object. In this example, the method also includes generating a background scene including a representation of the object, and while displaying the notification, highlighting the representation of the object to indicate that the object caused the planned change. In addition or alternatively, the method also includes identifying a relative area around the vehicle corresponding to a location of the object, and generating the notification is further based on the relative area such that the notification identifies the relative area. In another example, the method also includes providing an audible notification over a speaker of the vehicle, the audible notification identifying the type of the object and the relative area. In another example, the acceleration threshold includes a longitudinal acceleration threshold component and a minimum duration component. In another example, the acceleration threshold includes a lateral acceleration threshold component and a minimum duration component. In another example, the acceleration threshold includes a lateral acceleration threshold component, a longitudinal acceleration threshold component, and a maximum duration component. In another example, the acceleration threshold includes a first negative acceleration threshold, a second positive acceleration threshold component for a time subsequent to the first negative acceleration threshold, and a maximum duration component. In another example, the method also includes monitoring actual physical changes in lateral and longitudinal acceleration by the vehicle, and determining whether the acceleration threshold is met when the vehicle proceeds according to the actual physical changes, and generating the notification is further based on the determination that an acceleration threshold is met. In another example, the method also includes, controlling one or more actuators of the vehicle according to the instructions thereby causing the vehicle to meet the acceleration threshold, and wherein displaying the notification occurs during and after the vehicle meets the acceleration threshold. In another example, the method also includes controlling one or more actuators of the vehicle according to the instructions thereby causing the vehicle to meet the acceleration threshold, and wherein displaying the notification occurs before, during and after the vehicle meets the acceleration threshold.

Another aspect of the disclosure provides a system for generating notifications of acceleration events for a vehicle operating in an autonomous driving mode. The system includes one or more processors configured to monitor instructions generated by a planning system of the vehicle; determine that the instructions would result in changes in lateral and longitudinal acceleration for the autonomous driving mode; determine whether an acceleration threshold will be met when the vehicle proceeds according to the changes; generate a notification based on the determination that an acceleration threshold will be met, the notification identifying that an acceleration event has occurred; and display on a display of the vehicle the notification to a passenger of the vehicle.

In one example, the one or more processors are further configured to identify an object in the vehicle's environment that caused a change in the lateral and longitudinal acceleration corresponding to the acceleration event and to generate the notification further based on the object such that the notification identifies a type of the object. In addition, the one or more processors are further configured to generate a background scene including a representation of the object, and while displaying the notification, highlight the representation of the object to indicate that the object caused the planned change. In addition or alternatively, the one or more processors are configured to identify a relative area around the vehicle corresponding to a location of the object and to generate the notification further based on the relative area such that the notification identifies the relative area. In another example, the acceleration threshold includes a longitudinal acceleration threshold component and a minimum duration component. In another example, the acceleration threshold includes a lateral acceleration threshold component and a minimum duration component. In another example, the acceleration threshold includes a first negative acceleration threshold, a second positive acceleration threshold component for a time subsequent to the first negative acceleration threshold, and a maximum duration component. In another example, the system also includes the vehicle and the display.

### BRIEF DESCRIPTION OF THE DRAWINGS

FIG. 1 is a functional diagram of an example vehicle in accordance with an exemplary embodiment.

FIG. 2 is a functional diagram of an example system in accordance with an exemplary embodiment.

FIGS. 3A-3D are pictorial diagram of the system of FIG. 2 in accordance with aspects of the disclosure.

FIG. 4 is an example external view of a vehicle in accordance with aspects of the disclosure.

FIG. 5 is an example of a vehicle being maneuvered by planner system on roadway in accordance with aspects of the disclosure.

FIG. 6 is an example of sensor data from a perception system and a representation of a vehicle in accordance with aspects of the disclosure.

FIG. 7 is an example representation of relative areas around a vehicle in accordance with aspects of the disclosure.

FIG. 8 is a combination of the examples of FIGS. 6 and 7 in accordance with aspects of the disclosure.

FIG. 9 is an example notification which identifies an acceleration event.

FIG. 10 is an example display including a notification overlaid on a three-dimensional (3D) scene in accordance with aspects of the disclosure.

FIG. 11 is an example flow diagram in accordance with aspects of the disclosure.

### DETAILED DESCRIPTION

### Overview

Aspects of the technology relate to providing passengers with information about why autonomous vehicles or vehicles operating in an autonomous driving mode performed a particular maneuver. For instance, as noted above, sudden movements by the vehicle, even if for safety or other reasons, can cause anxiety or stress for the passenger. To reduce or avoid such discomfort, the vehicle's computing devices may generate and display notifications for certain acceleration events on an internal display of the vehicle in real time in order to provide the passenger with a greater sense of understanding and safety while being driven to the destination.

In order to generate these notifications, the computing devices must first be able to identify relevant events for notifications. Doing so may involve determining whether the vehicle has met certain discomfort metrics or acceleration thresholds. This may include monitoring instructions generated by the vehicle's planning system which plans how the vehicle will be controlled, and in particular, instructions which provide for abrupt changes in lateral and longitudinal acceleration. In addition to monitoring such messages, the computing devices may also monitor actual changes in lateral and longitudinal acceleration, for instance using an accelerometer, gyroscope, or other such device.

The acceleration thresholds may have multiple components. For instance, a given acceleration threshold may include a lateral acceleration threshold components, a longitudinal acceleration threshold component, and a duration threshold component. If an event meets one of these acceleration thresholds, a notification may be generated. In this regard, very high changes in acceleration (positive or negative) for very brief periods, high changes in acceleration for longer periods, as well as some patterns of changes in acceleration may trigger the generation of a notification. Of course, the thresholds used may affect the number and frequency of notifications, therefore there is a tradeoff between providing the notifications to ensure the passenger that the vehicle is operating properly and providing too many notifications which can be disturbing, uncomfortable, or even annoying to passengers.

Generating a notification may include determining what object in the vehicle's environment was the cause of the acceleration which met an acceleration threshold. This determination may be made based on information identifying objects in the vehicle's environment as well as their characteristics provided by the vehicle's perception system. For instance, the vehicle's computing systems may determine that an object is or will be near or in the vehicle's trajectory. In response, the computing devices may make a determination that the vehicle should yield for the object. If the decision to stop requires acceleration that meets one of the acceleration thresholds, the object may be determined to be the cause of the event.

This determination may be used to generate relevant text for the notification. For instance, the determined object's location may be used to identify a relative area around the vehicle. This in combination with the type of the object may be included in the notification in order to provide greater context about the event.

The notifications may be overlaid on a 3D scene of the vehicle's environment which includes representations of the objects identified by the perception system. The notification may then be displayed for a few seconds or until another notification for acceleration event or some other event is displayed. As noted above, the notification may identify the type of acceleration event, the type of the object that likely caused the acceleration event, as well as the relative area of the object.

The features described herein, may allow computing devices of an autonomous vehicle to provide notifications to a passenger based on planned and actual changes in acceleration. Because these notifications are happening in real time, they can provide a sense of reassurance and safety to the passenger thereby reducing any discomfort caused by sudden accelerations.

### Example Systems

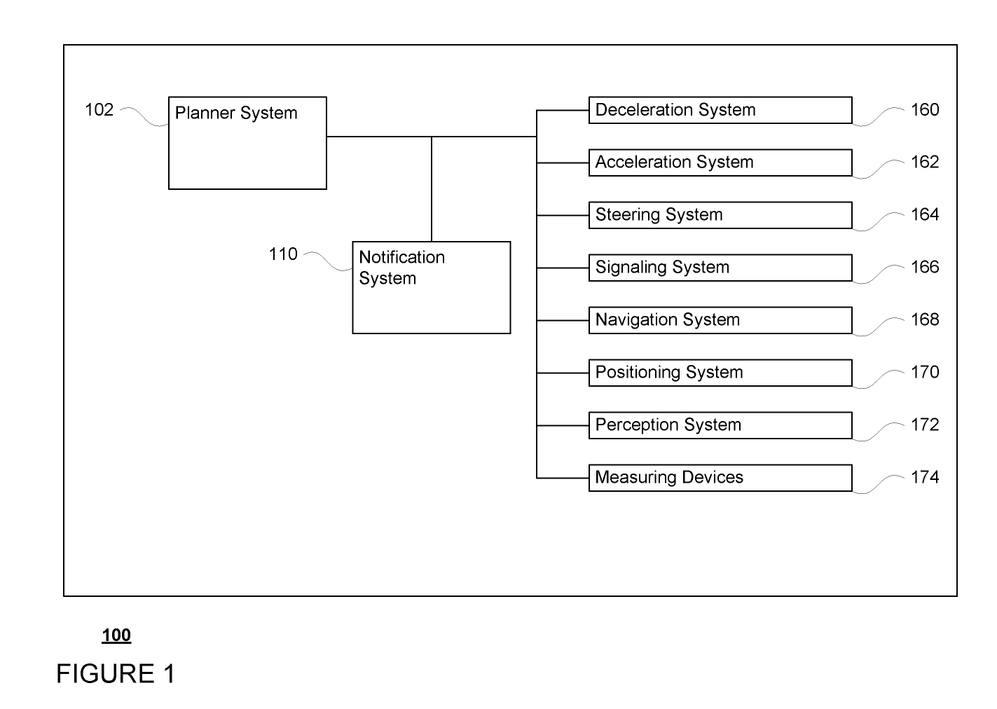

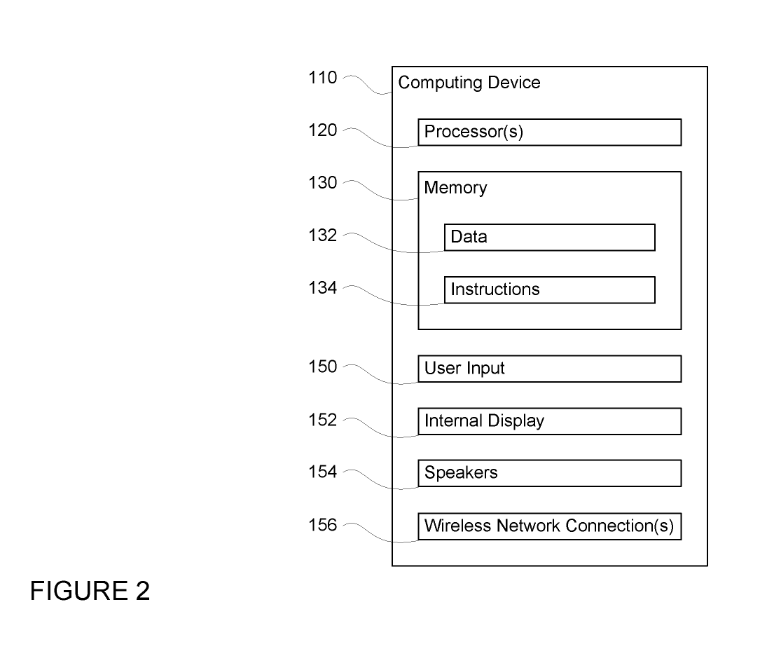

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices as shown in FIG. 2.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The data 132 may store discomfort metrics or acceleration thresholds which may include multiple components. For instance, a given acceleration threshold may include a lateral acceleration threshold components, a longitudinal acceleration threshold component, and a duration threshold component or minimum duration component. If an event meets one of these acceleration thresholds, a notification may be generated. In this regard, very high changes in acceleration (positive or negative) for very brief periods of time, high changes in acceleration for longer periods, as well as some patterns of changes in acceleration may trigger the generation of a notification. Of course, the acceleration thresholds used may affect the number and frequency of notifications, therefore there is a tradeoff between providing the notifications to ensure the passenger that the vehicle is operating properly and providing too many notifications which can be disturbing, uncomfortable, or even annoying to passengers.

The acceleration thresholds may be determined in various ways. For instance, passenger feedback for acceleration events, such as where passengers identify acceleration events that make them feel uncomfortable when they occur or immediately afterwards, can be used as a baseline for these thresholds. As an example, the acceleration thresholds can be determined by calibrating over a number of different responses from different passengers at different locations and points in time. As more feedback is received, machine learning can be used, for instance, to train a model for determining whether a notification is required. In this regard, using feedback from test drivers, a classifier can be trained to use acceleration changes and information to determine if a certain discomfort metric or acceleration threshold has been met, such that a notification should be generated as discussed further below.

As a more particular example, an acceleration threshold for a hard braking acceleration event may include at least a positive (acceleration) or negative (deceleration) change of 4.0-6.0 meters per second squared longitudinally, a change of 0 meters per second squared laterally, for a duration of no more than 0.3-0.5 seconds. Similarly, an acceleration threshold for a very hard braking acceleration event may include at least a positive (acceleration) or negative (deceleration) change of 4.0-6.0 meters per second squared longitudinally, a change of 0 meters per second squared laterally, for a duration of no more than 0.1-0.3 seconds. As another example, an acceleration threshold for a lateral jerk acceleration event may include at least a positive (acceleration) or negative (deceleration) change of 0.7-1.0 meters per second squared laterally, a change of 0 meters per second squared longitudinally, for a duration of no more than 0.1-0.3 seconds. In another example, an acceleration threshold corresponding to a “spike” acceleration event may include a longitudinal deceleration of 1.0-1.3 meters per second squared, followed by a longitudinal acceleration of 0.3-0.6 meters per second squared, with 0 or more lateral acceleration, for a duration of no more than 0.3-0.5 seconds.

The one or more processor 120 may be any conventional processors, such as commercially available CPUs. Alternatively, the one or more processors may be a dedicated device such as an ASIC or other hardware-based processor. Although FIG. 2 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing device 110 may function as a notification system in order to generate and provide information to a passenger of the vehicle 100. In this regard, the computing device 110 and/or other systems or computing devices of the vehicle may include an internal display 152 to provide visual information as well as one or more speakers 154 to provide audible information. In this regard, internal display 152 may be located within a cabin of vehicle 100 and may be used by a planner system 102 to provide information to passengers within the vehicle 100.

Computing device 110 may be able to monitor information or messages sent by different systems of vehicle 100. As will be understood, each of these systems, including, for example, planner system 102, deceleration system 160, acceleration system 162, steering system 164, signaling system 166, navigation system 168, positioning system 170, and perception system 172 may include one or more processors and memory storing data and instructions configured as described above with regard to processors 120, memory 130, data 132, and instructions 134.

Computing device 110 may monitor information sent and received by the planner system 102. In this example, planner system 102 may be part of an autonomous driving computing system incorporated into vehicle 100 configured to communicate with different systems and computing devices of the vehicle. For example, returning to FIG. 1, planner system 102 may be in communication with various systems of vehicle 100, such as deceleration system 160, acceleration system 162, steering system 164, signaling system 166, navigation system 168, positioning system 170, and perception system 172 in order to control the movement, speed, etc. of vehicle 100. In addition, the vehicle may include one or more measuring devices 174, such as accelerometers, gyroscopes, and/or speedometers, not shown, that can provide feedback about the current status of the vehicle to the planner system 102 in order to allow the computing device to correct for errors and make adjustments accordingly. Again, although these systems are shown as external to planner system 102 and computing device 110, in actuality, these systems may also be incorporated into planner system 102 and computing device 110, again as part of an autonomous driving computing system for controlling vehicle 100.

As an example, planner system 102 may interact with one or more actuators of the deceleration system 160 and/or acceleration system 162, such as brakes, the engine or motor of the vehicle, in order to control the speed of the vehicle. Similarly, one or more actuators of the steering system 164 may be used by planner system 102 in order to control the direction of vehicle 100. For example, if vehicle 100 is configured for use on a road, such as a car or truck, the steering system may include components to control the angle of wheels to turn the vehicle. Signaling system 166 may be used by planner system 102 in order to signal the vehicle's intent to other drivers or vehicles, for example, by lighting turn signals or brake lights when needed.

Navigation system 168 may be used by planner system 102 in order to determine and follow a route to a location. In this regard, the navigation system 168 and/or data 132 may store detailed map information, e.g., highly detailed maps identifying the shape and elevation of roadways, lane lines, intersections, crosswalks, speed limits, traffic signals, buildings, signs, real time traffic information, pull over spots vegetation, or other such objects and information.

Positioning system 170 may be used by planner system 102 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with planner system 102, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the planner system 102, other computing devices and combinations of the foregoing.

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by planner system 102. In the case where the vehicle is a small passenger vehicle such as a car, the car may include a laser or other sensors mounted on the roof or other convenient location.

The planner system 102 may control the direction and speed of the vehicle by communicating with the various systems and components of the vehicle. By way of example, planner system 102 may navigate the vehicle to a destination location completely autonomously using data from the detailed map information and navigation system 168. Planner system 102 may use the positioning system 170 to determine the vehicle's location and perception system 172 to detect and respond to objects when needed in order to generate a short term plan for maneuvering the vehicle in order to reach the destination location safely. In order to do so, planner system 102 may generate and send instructions that cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 160 may be a part of a drivetrain that includes various components between an engine of the vehicle and the wheels of the vehicle. Again, by controlling these systems, planner system 102 may also control the drivetrain of the vehicle in order to maneuver the vehicle autonomously.

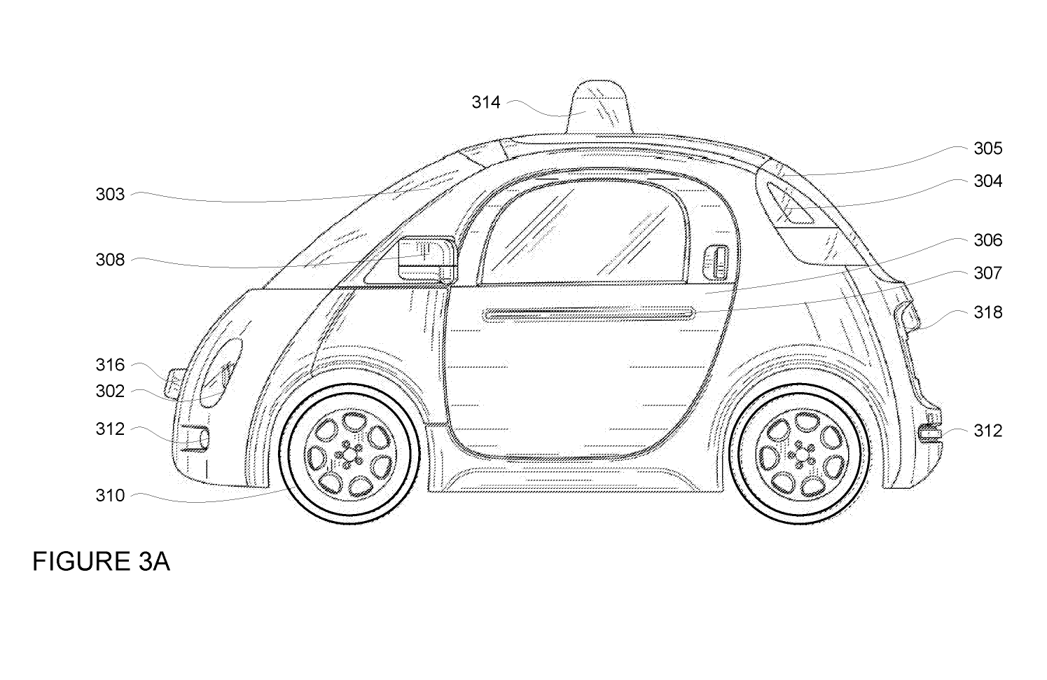

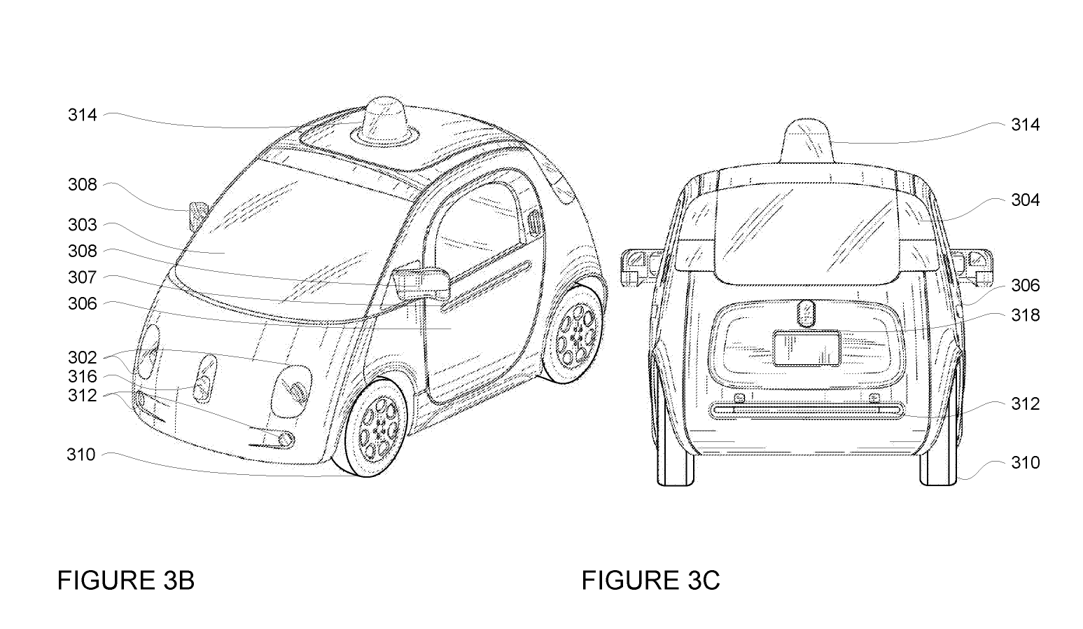

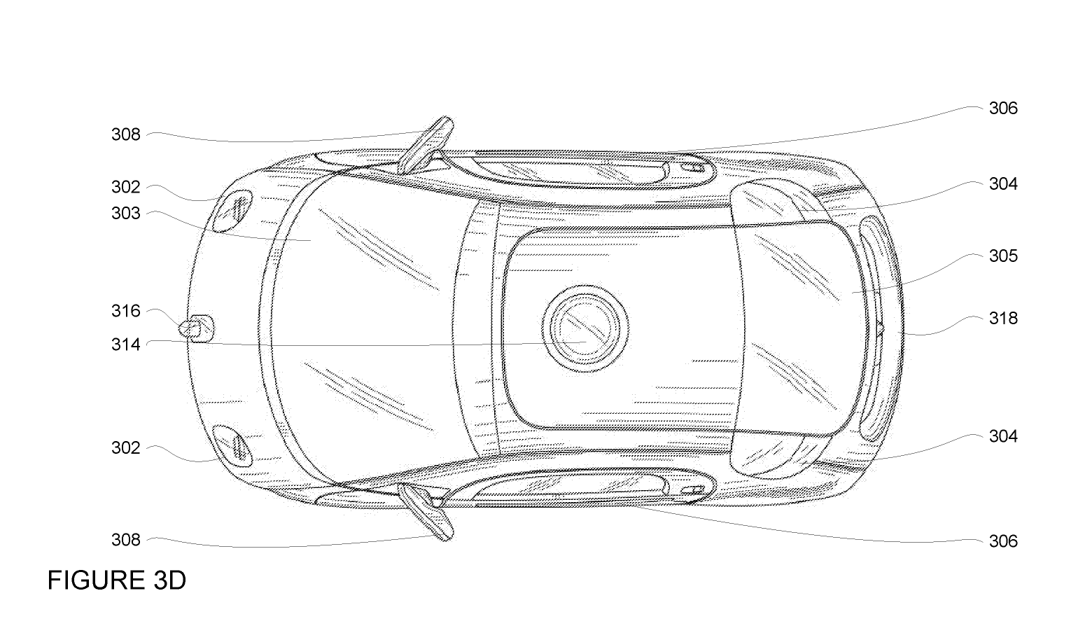

FIGS. 3A-3D are examples of external views of vehicle 100. As can be seen, vehicle 100 includes many features of a typical vehicle such as headlights 302, windshield 303, taillights/turn signal lights 304, rear windshield 305, doors 306, side view mirrors 308, tires and wheels 310, and turn signal/parking lights 312. Headlights 302, taillights/turn signal lights 304, and turn signal/parking lights 312 may be associated the signaling system 166. Light bar 307 may also be associated with the signaling system 166.

Vehicle 100 also includes sensors of the perception system 172. For example, housing 314 may include one or more laser devices for having 360 degree or narrower fields of view and one or more camera devices. Housings 316 and 318 may include, for example, one or more radar and/or sonar devices. The devices of the perception system may also be incorporated into the typical vehicle components, such as taillights/turn signal lights 304 and/or side view mirrors 308. Each of these radar, camera, and lasers devices may be associated with processing components which process data from these devices as part of the perception system 172 and provide sensor data to the planner system 102.

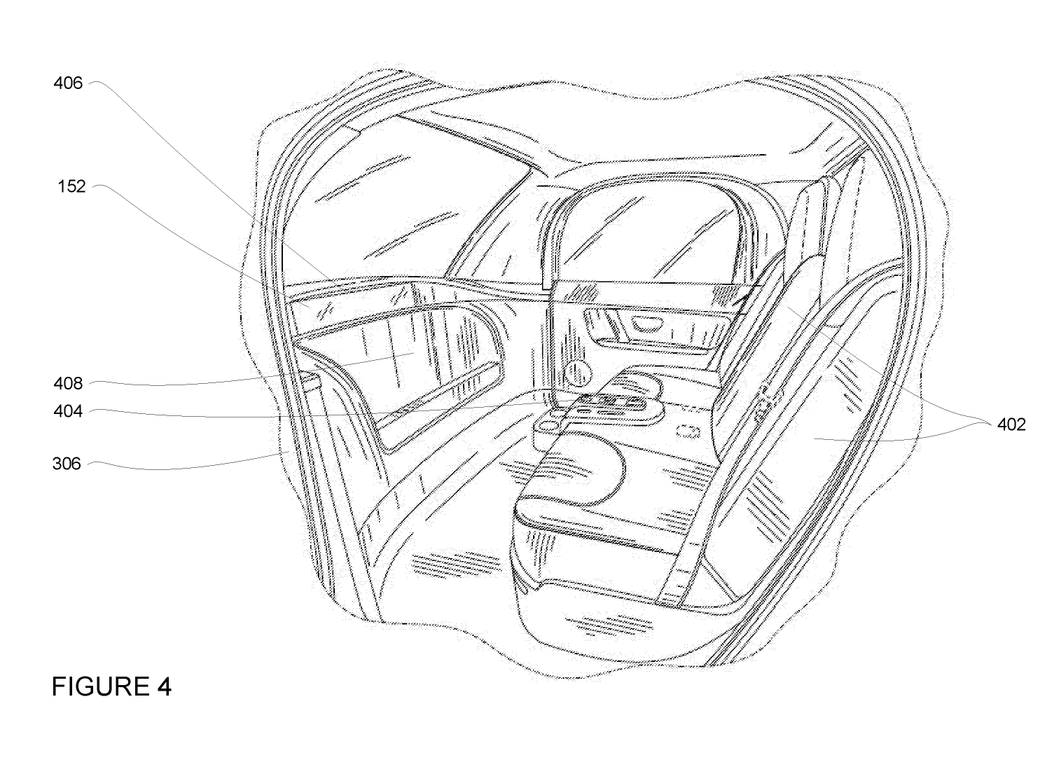

FIG. 4 is an example internal view of vehicle 100 through the opening of door 306. In this example, there are two seats 402 for passengers with a console 404 between them. Directly in ahead of the seats 402 is a dashboard configuration 406 having a storage bin area 408 and the internal display 152. As can be readily seen, vehicle 100 does not include a steering wheel, gas (acceleration) pedal, or brake (deceleration) pedal which would allow for a semiautonomous or manual driving mode where a passenger would directly control the steering, acceleration and/or deceleration of the vehicle via the drivetrain. Rather, user input is limited to a microphone of the user input 150 (not shown), features of the console 404, and wireless network connections 156. In this regard, internal display 152 merely provides information to the passenger and need not include a touch screen or other interface for user input. In other embodiments, the internal display 152 may include a touch screen or other user input device for entering information by a passenger such as a destination, etc.

In addition to the operations described above and illustrated in the figures, various operations will now be described. It should be understood that the following operations do not have to be performed in the precise order described below. Rather, various steps can be handled in a different order or simultaneously, and steps may also be added or omitted.

The planner system 102 may maneuver the vehicle 100 between two locations as described above. As part of this, the planner system 102 may also use information from the navigation system to identify a route to follow in order to reach a destination. While following the route to the destination, the vehicle may include one or more passengers. As noted above, it may be both important and useful to provide information to such passengers indicating why autonomous vehicles or vehicles operating in an autonomous driving mode performed a particular maneuver. In this regard, computing device 110 may generate and display notifications for certain acceleration events on an internal display, such as internal display 152, of the vehicle in real time in order to provide the passenger with a greater sense of understanding and safety while being driven to the destination. In order to generate these notifications, the computing device 110 may monitor information sent to and instructions provided by the planner system 102 to the acceleration and deceleration systems.

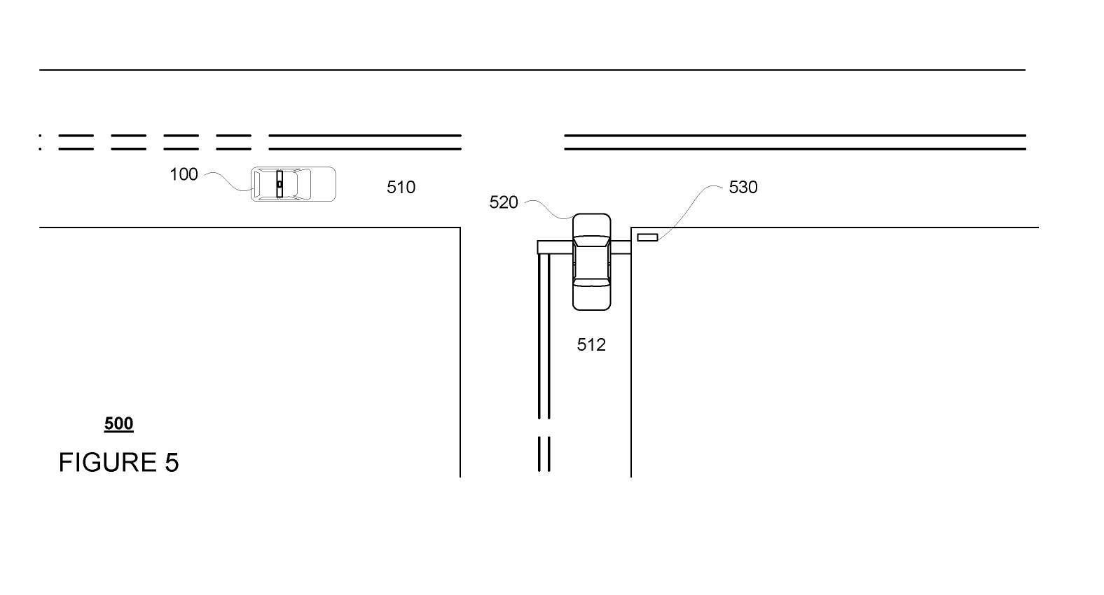

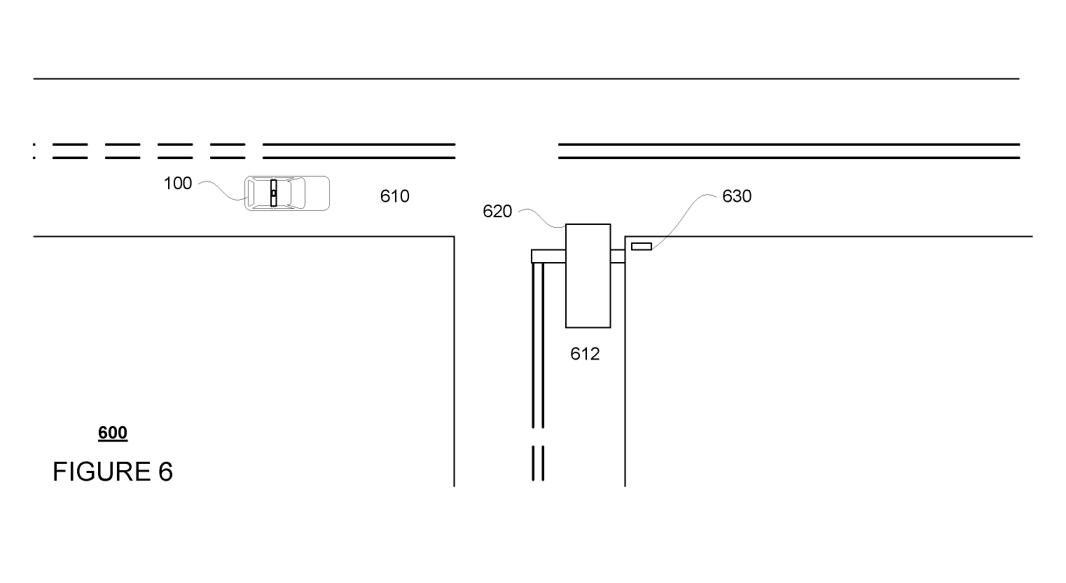

FIG. 5 is an example 500 of vehicle 100 being maneuvered by planner system 102 on roadway 610. In this example, vehicle 100 is approaching a connection with a roadway 512. Vehicles, such as vehicle 520, approaching roadway 510 from roadway 512 must stop according to a stop sign 530. As will be understood, FIGS. 6, 7, 8 and 9 discussed below represent overly simplified examples for ease of understanding.

As the vehicle moves along the roadway 510, the perception system 172 may use its sensors to detect and identify the characteristics various objects in the vehicle's environment including road features such as lane lines, the location of the road surface, curbs, crosswalks, etc. as well as objects such as pedestrians, bicyclists, vehicles, vegetation, etc. The characteristics of these objects, such as size, shape, location, heading, orientation, speed, type, etc. may be sent to the planner system 102 for processing. For instance, FIG. 6 is an example 600 of sensor data and a representation of vehicle 100 for the area of example 500. In this example, the perception system identifies features of roadway 610, roadway 612, vehicle 520 depicted as representation 620 for sensor data corresponding to vehicle 520, and stop sign 630 depicted as representation 630 for sensor data corresponding to stop sign 630. The details of these features may be sent to the planner system 102 for processing.

The planner system 102 may use the information from the navigation system in combination with the information provided by the perception system and the detailed map information to determine a plan for maneuvering the vehicle over a brief period of time into the future, such as several seconds or more or less. The plan may include a trajectory having both a geometry component and a speed component. The planner system 102 (or another computing device) may then use the plan to generate messages including instructions for maneuvering the vehicle in order to achieve the geometry component and the speed component. These instructions may then be used to and used by the acceleration, deceleration and steering systems to control the vehicle according to the plan.

Again, as these messages are sent to the acceleration, deceleration, and steering systems, the messages may be monitored by the computing device 110. For example, the computing device 110 may monitor messages from the perception system 172 to the planner system 102, messages from the planner system 102 to the acceleration system, messages from the planner system 102 to the deceleration system, messages from the planner system 102 to the steering system. In some instances, if the messages are sent over an Ethernet or CAN bus direct wiring or other means, the computing device may be connected to the Ethernet or CAN bus, wiring, etc. in order to allow for the monitoring.

Based on the monitoring, the computing device 110 may determine whether the instructions of the messages include instructions for maneuvering the vehicle in a way that would be considered an acceleration event. As an example, an acceleration event may correspond to a physical movement of the vehicle that would meet any of the acceleration thresholds of data 132. For instance, instructions which provide for abrupt changes in lateral and longitudinal acceleration may be considered an acceleration event that meets one of the acceleration thresholds. The acceleration changes can then be compared to the acceleration thresholds or input into the models described above, and if any such thresholds are met, the computing device 110 may generate a notification indicating that an acceleration event has or will occur (if there is enough time to do so). The notification may be generated and displayed as discussed further below.

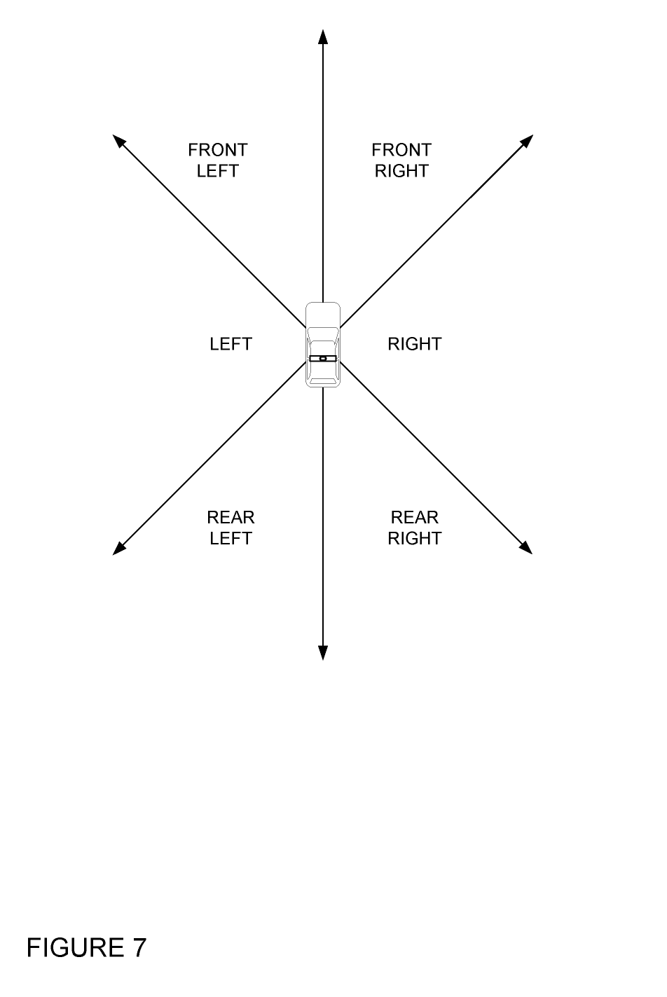

In addition to monitoring such messages, the computing device 110 may also monitor actual physical changes in lateral and longitudinal acceleration, for instance by monitoring messages sent to the planner system 102 by the monitoring devices 174 as shown in FIG. 7 or receiving messages directly from the monitoring devices 174. Again, these messages may be used to determine whether the vehicle, by its actual physical movements, has met any of the acceleration thresholds. For instance, the computing device 110 may monitor acceleration changes as reported by the monitoring devices 174 and apply filtering, such as low pass or other filtering to reduce noise in sensed acceleration values. The filtered acceleration changes can then be compared to the acceleration thresholds or input into the models described above, and if any such thresholds are met, and if a notification for the acceleration event has not already been generated based on the monitoring or instructions, the computing device 110 may generate a notification. Alternatively, this actual physical movement of the vehicle may be used to confirm an earlier determination, based on the instructions, that a notification should be generated.

In some instances, in addition to the instructions, the messages may contain additional information which identifies a reason why the vehicle took a particular action. For example, if a message includes instructions for accelerating the vehicle, the message may also include additional information identifying an object in the vehicle's environment that cause the vehicle to need to accelerate according to the instructions. The information identifying the object may include a location and type of object or further granularity such as size, shape, heading, orientation, speed, etc., may have been provided to the planner system 102 by the perception system 172.

For instance, returning to the examples of FIGS. 5 and 6, the planner system 102 may determine that an object identified by representation 620, such as vehicle 520, is or will be near or in the vehicle's trajectory. This may occur if vehicle 520 does not stop at the stop sign 530 or begins to move into roadway 510 from roadway 512. In response, the planner system 102 may make a determination that the vehicle should yield (slow down and/or stop) for vehicle 520.

The planner system 102 may then generate and send messages with instructions for the acceleration, deceleration and/or steering systems to cause the vehicle 100 to yield to vehicle 520. These messages may also identify the vehicle 520 or the representation 620 as being the cause for the changes in acceleration required by the instructions. The planner system 102 may determine whether the instructions which cause the vehicle 100 to yield require longitudinal and/or acceleration(s) that meet one of the acceleration thresholds. If so, the planner system 102 may identify an acceleration event. In this example, the vehicle 520 or representation 620 may also be determined to be the cause of the event. This determining may be performed automatically by the planner system 102 and/or 110 whenever the acceleration thresholds are met.

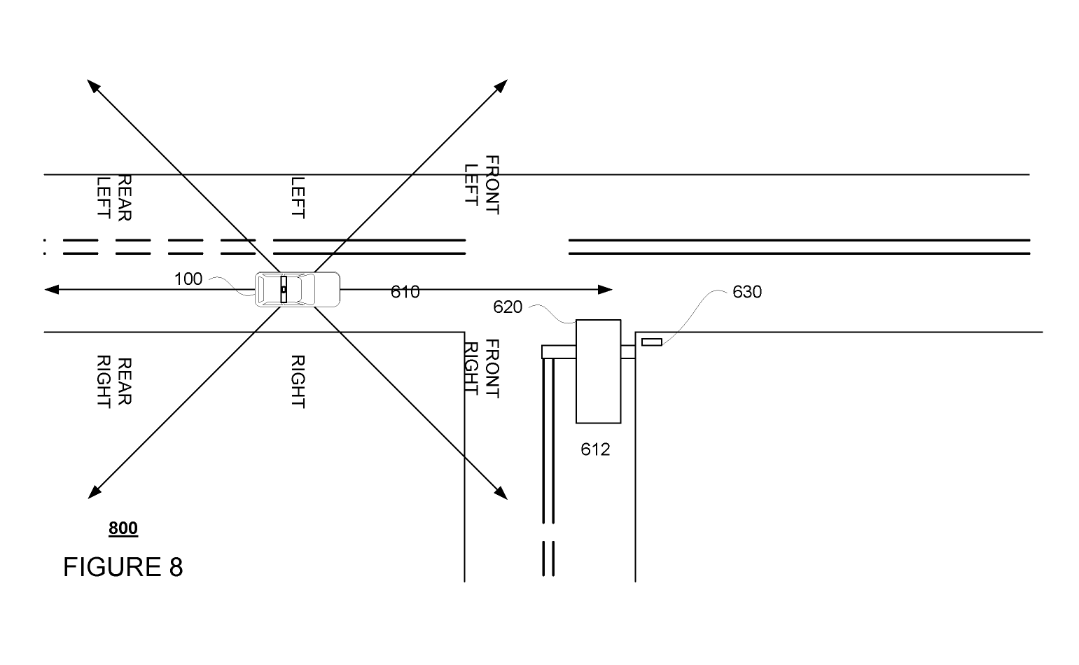

Again, an acceleration threshold is determined to be met by a particular instruction or instructions, the additional information may be used to generate relevant text for the notification. For instance, the determined object's location may be used to identify a relative area around the vehicle such as “front”, “rear”, “left”, “right”, or any combination of these relative to the direction of the vehicle. As shown in the example representation 800 of these relative areas of FIG. 7, +/−45 degrees where the direction of the vehicle is 0 degrees may be in front of the vehicle and so on. This in combination with the type of the object may be included in the notification in order to provide greater context about the event. Turning to FIG. 8, which combines the examples of FIGS. 6 and 7, the representation 720 (and/or vehicle 520) are located “front right” relative to the vehicle 100. This information may also be included in the notification.

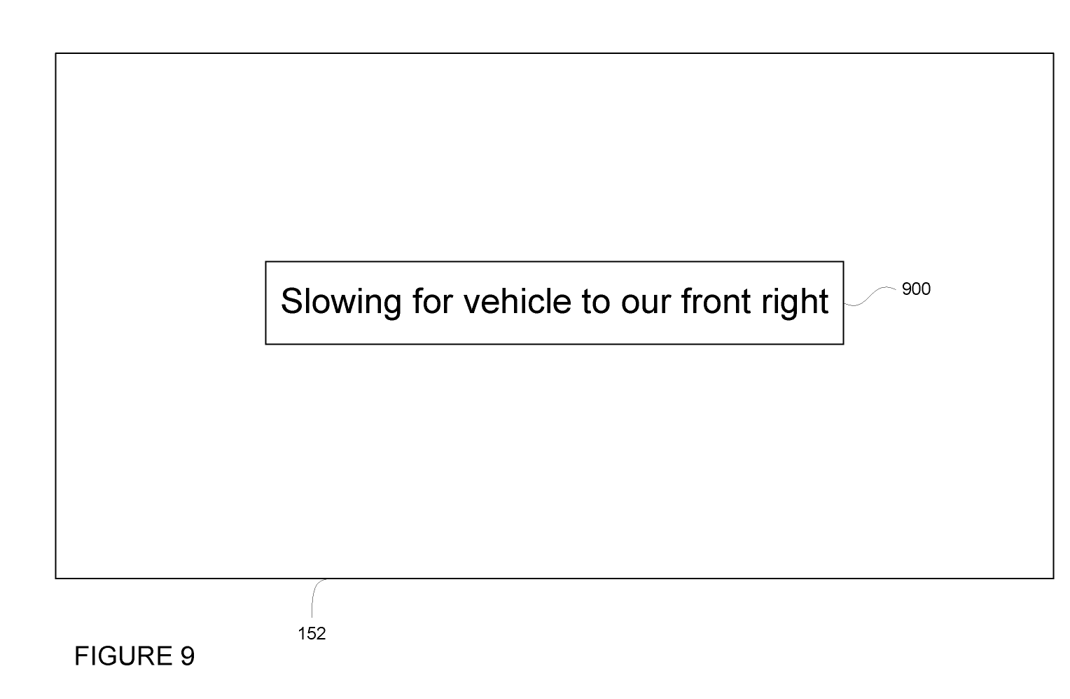

Once generated, the notification can be displayed on a display of the vehicle, such as internal display 152. As noted above, the notification may identify the type of acceleration event (braking or acceleration), the type of the object that likely caused the acceleration event (if known), as well as the relative area of the object (front, rear, left, right, or any combination of these). FIG. 9 is an example notification 900 depicted on internal display 152 which indicates an acceleration event just occurred for the example above. In this example, notification 900 identifies that the vehicle 100 slowed for a vehicle (really, vehicle 520) located to the front right of vehicle.

Given that the notification may be generated before the vehicle actually physically completes the acceleration event. Such notifications may be displayed before, during, and/or after the acceleration event for some predetermined period of time such as 4 seconds or 7 seconds or more or less or until a new notification for another acceleration event or some other event is displayed. In some examples, immediately before or when the notification is displayed, a chime or other noise may be played in order to gain the passenger's attention and direct it towards the display. In addition, or alternatively, an audio notification may be provided for passengers who are situated in a seat where a display screen is not visible or who otherwise would have difficulty seeing a display. This provides any passengers with real time information about what the vehicle is doing and why.

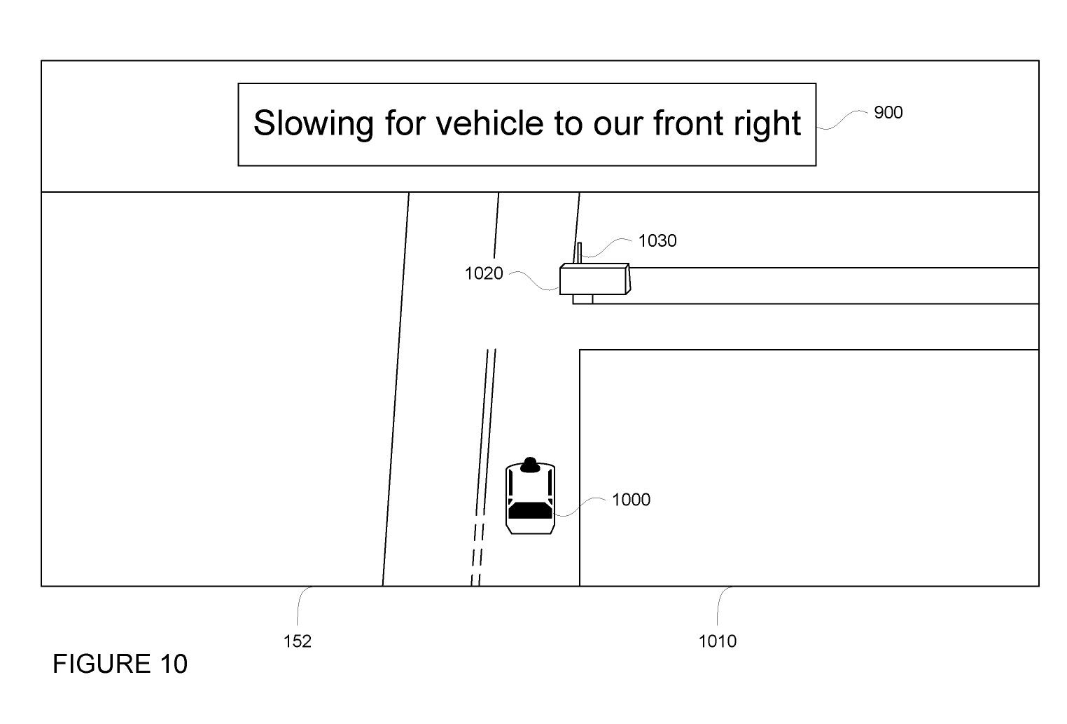

In order to provide the passenger with even more context about an acceleration event, the notifications may be overlaid on a background scene such as a 3D scene of the vehicle's environment. As shown in FIG. 10, notification 900 is overlaid onto a 3D scene 1010 displayed on internal display 152. The 3D scene includes representations of the objects, such as representation 1000 for vehicle 100, representation 1020 for vehicle 520/representation 620, and representation 1030 for stop sign 530/representation 630, identified by the perception system 172 which may be combined with the map information.

In some instance, the representation corresponding to the object that likely caused the acceleration event may be flagged or highlighted. As an example, the representation 1020 may appear to glow or change color (e.g. from blue to red or green to red, etc.) during the time that the notification is displayed on the display. In addition or alternatively, icons can be overlaid on the representation corresponding to the object in a billboard style (i.e. vertical in the 3D space and facing a virtual camera corresponding to the orientation of the view of the 3D scene). In addition or alternatively, an area of the road surface around representation 1000 for vehicle 110 may be highlighted in a direction corresponding to the object responsible for the acceleration change.

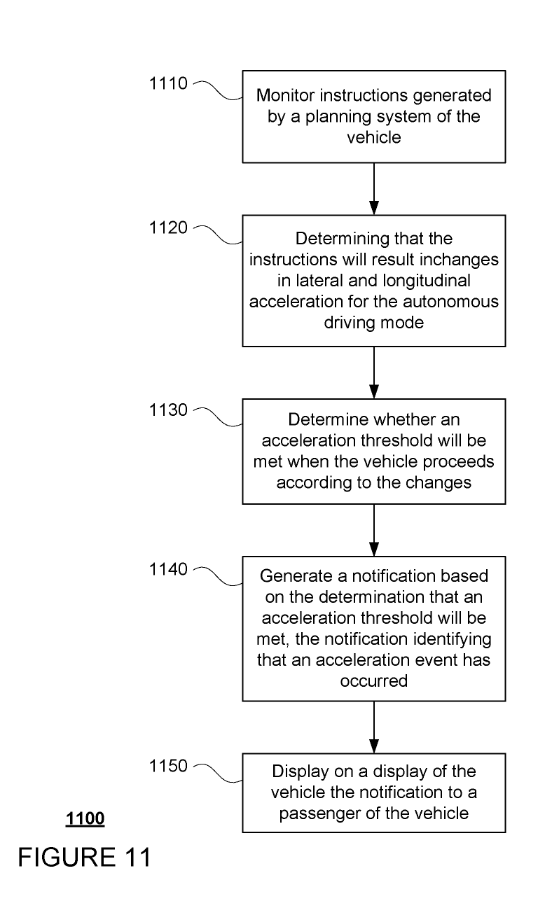

FIG. 11 is an example flow diagram 1100 which may be performed by the planner system 102 in order to identify an acceleration event for a vehicle operating in an autonomous driving mode and generate a corresponding notification. For instance, at block 1110, instructions generated by a planning system of the vehicle are monitored. Determining that the instructions would result in changes in lateral and longitudinal acceleration for the autonomous driving mode at block 1120. At block 1130, whether an acceleration threshold will be met when the vehicle proceeds according to the changes at a time in the future is determined. At block 1140, a notification is generated based on the determination that an acceleration threshold will be met, the notification identifying that an acceleration event has occurred. At block 1150, the notification is displayed on a display of the vehicle to a passenger of the vehicle.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of generating notifications of acceleration events for a vehicle operating in an autonomous driving mode, the method comprising:
monitoring, by one or more processors, instructions generated by a planning system of the vehicle;
determining, by the one or more processors, that the instructions would result in an acceleration event including an imminent changes in lateral or longitudinal acceleration for the autonomous driving mode;
determining, by the one or more processors, that an acceleration threshold will be met when the vehicle proceeds according to the changes;
generating, by the one or more processors, before the acceleration event occurs and based on the determination that an acceleration threshold will be met, a first notification to a passenger of the vehicle that the acceleration event is about to occur;
generating, by the one or more processors, a second notification providing more context about the acceleration event; and
displaying, by the one or more processors, on a display of the vehicle the second notification to the passenger of the vehicle.

2. The method of claim 1, further comprising identifying an object in the vehicle's environment that caused a change in the lateral or longitudinal acceleration corresponding to the acceleration event, and wherein generating the second notification is further based on the object such that the second notification identifies a type of the object.

3. The method of claim 2, wherein displaying the second notification further includes:
generating a background scene including a representation of the object; and
while displaying the second notification, highlighting the representation of the object to indicate that the object caused the planned change.

4. The method of claim 2, wherein displaying the second notification further includes identifying a relative area around the vehicle corresponding to a location of the object, and wherein generating the second notification is further based on the relative area such that the second notification identifies the relative area.

5. The method of claim 1, wherein the second notification is an audible notification over a speaker of the vehicle, the audible notification identifying a type of the object and the relative area.

6. The method of claim 1, wherein the acceleration threshold includes a longitudinal acceleration threshold component and a minimum duration component.

7. The method of claim 1, wherein the acceleration threshold includes a lateral acceleration threshold component and a minimum duration component.

8. The method of claim 1, wherein the acceleration threshold includes a lateral acceleration threshold component, a longitudinal acceleration threshold component, and a maximum duration component.

9. The method of claim 1, wherein the acceleration threshold includes a first negative acceleration threshold, a second positive acceleration threshold component for a time subsequent to the first negative acceleration threshold, and a maximum duration component.

10. The method of claim 1, further comprising:
monitoring actual physical changes in lateral or longitudinal acceleration by the vehicle; and
determining whether the acceleration threshold is met when the vehicle proceeds according to the actual physical changes, and wherein generating the second notification is further based on the determination that an acceleration threshold is met.

11. The method of claim 1, further comprising controlling one or more actuators of the vehicle according to the instructions thereby causing the vehicle to meet the acceleration threshold, and wherein displaying the second notification occurs during and after the vehicle meets the acceleration threshold.

12. The method of claim 1, further comprising controlling one or more actuators of the vehicle according to the instructions thereby causing the vehicle to meet the acceleration threshold, and wherein displaying the second notification occurs before, during and after the vehicle meets the acceleration threshold.

13. A system for generating notifications of acceleration events for a vehicle operating in an autonomous driving mode, the system comprising one or more processors configured to:
monitor instructions generated by a planning system of the vehicle;
determine that the instructions would result in an imminent change in lateral or longitudinal acceleration for the autonomous driving mode;
determine that an acceleration threshold will be met when the vehicle proceeds according to the changes;
generate before the acceleration event occurs and based on the determination that an acceleration threshold will be met, a first notification to a passenger of the vehicle that an acceleration event is about to occur;
generate a second notification providing more context about the acceleration event; and
display on a display of the vehicle the second notification to the passenger of the vehicle.

14. The system of claim 13, wherein the one or more processors are further configured to identify an object in the vehicle's environment that caused a change in the lateral and longitudinal acceleration corresponding to the acceleration event and to generate the notification further based on the object such that the notification identifies a type of the object.

15. The system of claim 14, wherein the one or more processors are further configured to:
generate a background scene including a representation of the object; and
while displaying the second notification, highlight the representation of the object to indicate that the object caused the planned change.

16. The system of claim 14, wherein the one or more processors are further configured to identify a relative area around the vehicle corresponding to a location of the object and to generate the second notification further based on the relative area such that the second notification identifies the relative area.

17. The system of claim 13, wherein the acceleration threshold includes a longitudinal acceleration threshold component and a minimum duration component.

18. The system of claim 13, wherein the acceleration threshold includes a lateral acceleration threshold component and a minimum duration component.

19. The system of claim 13, wherein the acceleration threshold includes a first negative acceleration threshold, a second positive acceleration threshold component for a time subsequent to the first negative acceleration threshold, and a maximum duration component.

20. The system of claim 13, further comprising the vehicle and the display.

21. The method of claim 1, wherein the first notification is an audio cue played in order to gain the passenger of the vehicle's attention and direct the passenger of the vehicle towards the display.
